(19) United States
(12) Patent Application Publication
(10) Pub. No.: US 2026/0037850 A1
(43) Pub. Date: Feb. 5, 2026

(54) QUANTUM COMPUTING DEVICE AND METHOD FOR PREDICTING QUANTUM TRAJECTORIES AND MANAGING DECOHERENCE USING DYNAMIC EQUILIBRIUM OPERATIONS, RADIX WAVES, AND A ROTATIONAL HELICAL DIMENSIONAL MODEL OF COMPLEX NUMBERS

(71) Applicant: Pil Sung KANG, Busan (KR)

(72) Inventor: Pil Sung KANG, Busan (KR)

(21) Appl. No.: 19/276,333

(22) Filed: Jul. 22, 2025

(30) Foreign Application Priority Data
Aug. 2, 2024 (KR) 10-2024-0102983

(51) Int. Cl. G06N 10/60

(52) U.S. Cl. CPC G06N 10/60

(57) ABSTRACT

Disclosed are a quantum computing device for predicting a trajectory of a quantum and managing decoherence of the quantum by using a dynamic equilibrium operation, a base number wave, and a rotational spiral ascension dimension model of a complex number, and a method thereof. The quantum computing device may prevent the collapse of a quantum state and enhance stability by predicting and managing a critical point where quantum decoherence occurs, due to maintaining the periodicity and stability of a signal through complex rotation and carry-and-offset rules.

### CROSS-REFERENCE TO RELATED APPLICATIONS

A claim for priority under 35 U.S.C. § 119 is made to Korean Patent Application No. 10-2024-0102983 filed on Aug. 2, 2024 in the Korean Intellectual Property Office, the entire contents of which are hereby incorporated by reference.

### BACKGROUND

Embodiments of the present disclosure described herein relate to a technology for stably maintaining and controlling the state of a qubit, which is the basic unit of quantum computing, and controlling and mitigating the phenomenon that the state of a qubit collapses while interacting with an external environment, and more particularly, relate to a quantum computing device for predicting a trajectory of a quantum and managing decoherence of a quantum that may reduce an error rate of quantum computing and increase the stability by identifying dimension transition motion of a quantum through a dynamic equilibrium operation for predicting the state of a variable structure of a dynamical system, and a base number wave that is a wave theory based on the number system.

Unlike a general computer, quantum computing adds a device to physically control and manage quanta in the early stages.

At this time, diverse algorithms may be used for each device. In this case, the development of new algorithms requires new theories.

The reason is that inferring quantum states necessitates diverse methodologies.

In the meantime, the reason for the error rate of conventional quantum computing devices is that quanta are too sensitive. When they interact with external environments, their properties break down.

Accordingly, there is a critical need to develop quantum computing devices that may prevent the collapse of quantum states and increase their stability.

### SUMMARY

Embodiments of the present disclosure provide a method for preventing the collapse of a quantum state and enhancing stability by predicting and managing a critical point where decoherence of a quantum occurs, due to maintaining the periodicity and stability of a signal through complex rotation and carry-and-offset rules.

Problems to be solved by the present disclosure are not limited to the problems mentioned above, and other problems not mentioned will be clearly understood by those skilled in the art from the following description.

According to an embodiment, a quantum computing device that predicts a trajectory of a quantum and manages decoherence of the quantum by using a dynamic equilibrium operation, a base number wave, and a rotational spiral ascension dimension model of a complex number includes a memory that stores at least one process related to managing the decoherence of the quantum and predicting the trajectory of the quantum, and a processor that performs an operation according to the process. The processor includes a first module that divides an input qubit signal of quantum computing into a prime number signal and a composite number signal, a second module that rotates the divided prime number signal based on a vertex, which is formed in a 3D cone unit within the rotational spiral ascension dimension model of the complex number, performs a predetermined offset operation on the rotated prime number signal whenever a carry occurs in the rotated prime number signal, and analyzes a critical point where the decoherence of the quantum occurs, based on the rotated prime number signal, and a third module that outputs a stabilized prime number signal, in which the predetermined decoherence of the quantum does not occur, when the rotated prime number signal reaches the critical point, and generates a final output signal by recombining the stabilized prime number signal, and the composite number signal.

Moreover, the first module may use a zeta function of the base number wave that applies a weight to each of the prime number signal and the composite number signal when dividing the qubit signal into the prime number signal and the composite number signal.

Furthermore, the second module may initialize the rotated prime number signal while performing the offset operation on the rotated prime number signal when the carry occurs in the rotated prime number signal.

Also, the second module may use a 0-point interaction function when analyzing the critical point where the decoherence of the quantum occurs.

Besides, the second module may use the 0-point interaction function, to which a function indicating a smooth transition in the complex plane is applied, when analyzing the critical point where the decoherence of the quantum occurs.

In addition, the function indicating the smooth transition may be a sigmoid function.

Moreover, the third module may initialize the rotated prime number signal while performing the predetermined offset operation on the rotated prime number signal when the rotated prime number signal reaches the critical point.

Furthermore, the third module may generate a final output signal by repeatedly recombining the stabilized prime number signal and the composite number signal until the recombined final output signal satisfies the quality criterion of the reference output signal when the recombined final output signal does not satisfy a quality criterion of a predetermined reference output signal.

According to an embodiment, a method of predicting a trajectory of a quantum and managing decoherence of the quantum by using a dynamic equilibrium operation, a base number wave, and a rotational spiral ascension dimension model of a complex number, which is performed by a quantum computing device includes dividing, by a first module of the quantum computing device, an input qubit signal of quantum computing into a prime number signal and a composite number signal, rotating, by a second module of the quantum computing device, the divided prime number signal based on a vertex, which is formed in a 3D cone unit within the rotational spiral ascension dimension model of the complex number, performing, by the second module, a predetermined offset operation on the rotated prime number signal whenever a carry occurs in the rotated prime number signal, analyzing, by the second module, a critical point where the decoherence of the quantum occurs, based on the rotated prime number signal, outputting, by a third module of the quantum computing device, a stabilized prime number signal, in which the predetermined decoherence of the quantum does not occur, when the rotated prime number signal reaches the critical point, and generating, by the third module, a final output signal by recombining the stabilized prime number signal, and the composite number signal.

Besides, a computer program stored in a computer-readable recording medium for executing a method to implement the present disclosure may be further provided.

In addition, a computer-readable recording medium for recording a computer program for performing the method for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram illustrating a quantum computing device that predicts a trajectory of a quantum and manages decoherence of a quantum, according to an embodiment of the present disclosure;

FIG. 2 is a diagram showing a configuration of the quantum computing device of FIG. 1;

FIG. 3 is a diagram showing a configuration of a processor of FIG. 2; and

FIGS. 4 to 13 are diagrams illustrating a process of predicting a trajectory of a quantum and managing decoherence of a quantum, according to an embodiment of the present disclosure.

### DETAILED DESCRIPTION

The same reference numerals denote the same elements throughout the present disclosure. The present disclosure does not describe all elements of embodiments. Well-known content in a technical field to which the present disclosure belongs or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Descriptions of the present disclosure are not limited to embodiments for structural or functional descriptions. Because this may be changed variously and may take many forms, the claim scope of the present disclosure includes all modifications capable of realizing the technical idea. The stated purposes or effects are not limited to specific embodiments, and thus, the scope of rights of the present disclosure should not be restricted for such reasons.

Terms such as ‘1’, ‘2’, or the like used herein to indicate order, or terms such as a ‘critical point’ used to describe a module in the present disclosure are merely for distinguishing components from each other and do not serve to limit the scope of claims. For example, the components mentioned may be renamed. The expression “being connected” may include both direct and indirect connections, and should be interpreted flexibly when describing relationships between components.

The present disclosure may be implemented as computer-readable codes and may be stored in various types of computer-readable recording media. It may be included in various electronic device storage devices, and may also be stored and executed in a distributed manner over a network. Terms used have meanings generally understood in the field to which the present disclosure pertains, and should be interpreted according to their ordinary meanings unless specifically defined otherwise.

The present disclosure may theoretically predict the collapse of the trajectory of a quantum by interpreting it as a dimensional transition called the vertex of a spiral rotation (i.e., 0-point convergence). The present disclosure may infer the forms of various mathematical difficult problems. That is, the present disclosure may consistently identify the structure of core difficult problems such as the form of a Riemann zeta function and a Collatz sequence, and thus may infer actual mathematical properties.

The present disclosure may manage decoherence of a quantum by implementing a dynamic equilibrium operation, a base number wave, and a spiral ascension dimension model, which are mathematical models and theories that infer a quantum dynamic system.

A key mathematical concept in algorithm design is a dynamic equilibrium operation (DEO). The dynamic equilibrium operation refers to a theory developed to create an algorithm that inputs concepts of time, motion, and energy into a mathematical operation structure such that a mathematical operation has physical dimensions and dynamic properties. In this way, the dimensional structure and the dynamical system of a quantum may be inferred by connecting the mathematical rigor and computational structure of the microscopic world governed by quantum mechanics through a theory.

The present disclosure relates to the main node of a quantum spiral ascension dimensional model signal processing algorithm based on a dynamic equilibrium operation and a base number wave, and predicts and manages decoherence that causes an error rate in the control software of quantum operation gates for data processing of a quantum computer through a quantum structure transition motion.

The dynamic equilibrium operation refers to a theoretical framework for maintaining the stability of a quantum state and alleviating the decoherence. This approach based on the dynamic equilibrium operation maintains the dynamic stability of a system through the balance of the increase and offset of variables. In other words, the dynamic equilibrium operation creates a symmetrical structure called a variable offset such that all variables and a 0-point, which is a starting point that is no variable, may achieve dynamic equilibrium. According to the logical idea that mathematical rigor operates in microscopic worlds because variables become simpler, the logical rules of the transition mechanism in a state where a variable is generated are created while there is no variable.

The core of the theory of the dynamic equilibrium operation is the rule that the increase of a variable starting from point 0 appears as the motion of complex rotation when 0 is assumed as a state where there is no variable. The basic principle of complex rotation is to create a symmetrical structure called the increase and offset of variables from the perspective of a zero point, and the symmetrical structure creates a rotation circle of a balanced arrangement of real and imaginary parts. The variables are created to move like waves by matching this concept with variables, so as to have a geometric dimension increase structure.

The logical structure of the dynamic equilibrium operation is based on the mathematical rigor and the symmetrical structure of the increase and offset of variables in the microscopic world. It provides a new approach to intuitively understand and explain the phenomena observed in quantum mechanics. In quantum mechanics, the more microscopic the world, the more strongly mathematical rigor acts. In describing the state of a particle and its change, the role of wave functions and operators is important. Quantum states are often represented as complex numbers, which include rotational symmetries between the real and imaginary parts, include aspects of geometry and topology, complex numbers and complex number functions, and calculus and analytic calculus. Physical background includes aspects of the wave equation of quantum mechanics, the theory of relativity, dynamics, and nonlinear systems. These theories search for complex rotation mechanisms common to physics.

The balanced arrangement of the real and imaginary parts of complex rotation is described as a motion mechanism for a dynamic equilibrium operation in mathematics, which may be used to intuitively understand and interpret complex phenomena in quantum mechanics. These rules create the basis for the wave-structured number system and the spiral ascension dimension model. The dynamic equilibrium operation utilizes the principle of complex rotation to balance a system by repeatedly performing the increase and offset of variables. In this case, the dimension created by the complex rotation structure is used to predict and control changes in the quantum state, and is particularly useful for solving decoherence problems.

In quantum mechanics, the wave function ψ(r,t) is represented by a complex number, which is a combination of real and imaginary parts. From the perspective of dynamic equilibrium operation theory, the change in the wave function may be described through the complex rotation. This is interpreted as a cyclic process of increasing and offsetting variables.

$$ψ ( r , t ) = A ( r , t ) {e}^{i θ ( r , t )}$$

Here, A(r,t) denotes the amplitude and θ(r,t) denotes the phase.

These mathematical expressions may be reinterpreted through the concepts of complex rotation and the increase and offset of variables of the dynamic equilibrium operation by using the Schrödinger equation.

The dynamic equilibrium operation forms a dimensional structure through dynamic equilibrium of the increase and offset of variables. This is represented by a spiral pattern and is used to describe changes in high-dimensional space.

The dynamic equilibrium operation connects the basic number system (variables) with geometric dimensions. This describes how the increase of mathematical variables forms a dimensional structure. New dimensions are created by increasing and offsetting variables, which is represented through complex rotation and spiral patterns.

In conventional quantum mechanics, it was difficult to accurately identify the dynamic mechanism of quantum mechanics, thereby making classical physical interpretation difficult. This may be seen as an error in dimension interpretation. The uncertainty principle, which indicates that the position and momentum of a quantum is incapable of being accurately measured simultaneously, represents a limitation of linear analysis. Superposition states of wave functions represent quantum phenomena that are difficult to be explained by using classical physics.

The dynamic equilibrium operation creates a link between the number system and the geometric dimension, thereby providing a more intuitive interpretation of quantum mechanics. Frameworks of a quantum computing algorithm may be added according to rules of dynamic equilibrium operation.

The dynamic equilibrium operation refers to a new mathematical dimensional model for solving the boundary problem between quantum mechanics and classical physics. The core idea of the dynamic equilibrium operation indicates that the complex rotation mechanism is considered as a motion of the increase and offset of variables, and the complex rotation is included as a key element of the operation. In this way, new information may be obtained by connecting operations, number systems, and geometric dimensional structures. The present disclosure using the dynamic equilibrium operation provides a theoretical basis for collectively explaining mathematical and physical phenomena, and establishes a link between quantum mechanics and classical physics to predict and manage quantum computational processes.

The dynamic equilibrium operation is a powerful tool that may overcome the limitations of conventional mathematics and may provide a new perspective on complex phenomena. Complex multidimensional spaces may be intuitively explained through the concept of a base number wave (BNW) and a spiral ascension dimension model (SADM) structure established as the dynamic equilibrium operation theory. The dynamic equilibrium operation may interpret quantum mechanical phenomena from a new perspective through the concepts of the increase and offset of variables and complex rotation.

The change of the wave function may be intuitively understood by describing the periodic change of a quantum state as the complex rotation. Through a motion created by using variables, wave-particle duality being the core of quantum mechanics may be explained by using the spiral ascension dimension model. The interactions and transitions of quantum states may be understood through a spiral structure.

Moreover, changes in dynamic systems may be effectively analyzed through a process of increasing and offsetting variables. Temporal changes may be intuitively understood through the dynamic equilibrium operation by explaining the dynamic change of a variable as the increase and offset of variables.

The decoherence refers to quantum collapse. In quantum computing, the decoherence of a qubit indicates a phenomenon that a quantum state loses quantum properties due to the influence of the external environment, which means increasing errors of a quantum computer. Through a complex number spiral rotation modeling of the variable, the present disclosure predicts being interpreted as a quantum collapse phenomenon by existing quantum computing companies, as a mechanism, in which a quantum interacts with a variable to transform its dimension. From this perspective, the stability of qubits may be improved by managing a dimensional transition critical point through complex rotation of a prime number signal.

The base number wave refers to a concept that is not present in existing mathematics, and relates to a method of creating number waves by combining complex rotation with a number system. In other words, the base number wave refers to a method of drawing a trajectory whenever an operation is performed, and creating a geometric dimensional structure by using the trajectory. With this model, a rotational spiral dimension of a three-dimensional (3D) cone unit may be created as the dimension created by the operation. Unlike the conventional mathematical method, this theory may be explained by using the geometric dimension of mathematics in a spiral dimension. This approach is based on the fact that nature actually has a spiral structure and opens up a lot of new interpretations.

The base number wave is a wave theory based on the number system of a BNW system. When numbers increase by applying the dynamic equilibrium rule of complex rotation to variables, they are arranged in a complex number spiral structure. In this rule, differences between prime numbers and composite numbers indicate that only prime numbers have an assignment angle radian independent of complex rotation. The input signal is classified into a prime number and a composite number by using the rule, and critical points are managed for each signal. At this time, the base number wave forms a wave structure based on complex rotation motion by assigning numbers to specific angles. The base number wave may be utilized in fields such as signal processing, frequency analysis, and data classification.

Nowadays, quantum mechanics has many unsolved mysteries, such as quantum gravity, and lacks an intuitive understanding of the phenomenon. Therefore, inventing quantum computing algorithms requires a new theory of quantum mechanics. The quantum spiral ascension dimension signal processing algorithm of the present disclosure first creates a quantum dynamical system theory and reflects the quantum dynamical system theory.

The quantum dynamical system theory introduces the concept of waves into the numerical system of variables, and thus draws a trajectory whenever an operation is performed. The complex rotation is divided by number ‘N’ such that each number has its own assignment angle radian. Accordingly, the dynamic trajectory of the quantum may be inferred by using computer algorithms. Thus, the process of dimensional transition and variable increase of a quantum may be predicted and managed. The computer algorithm of the present disclosure may reduce the error rate of a quantum computer by managing decoherence by inferring a quantum dynamical system. This is a model that infers a specific quantum dynamic mechanism compared with the perspective of existing theories.

The inference of the dynamical mechanism of a quantum provides a new perspective on the existing decoherence management. The differences from the existing method are as follows. The existing error rate managing algorithm interprets the cause of the error rate as a quantum collapse phenomenon caused by interaction with the external environment. On the other hand, the present disclosure determines a quantum as an information structure and interprets that interaction with the external environment creates an increase in information variables. As the variable increases, a quantum creates a critical point for dimension transition. The present disclosure presents a new perspective on predicting and managing these quantum properties. The algorithm of the present disclosure, which reflects this new perspective, provides an important theoretical frame that may contribute to the development of quantum computing.

Hereinafter, operating principles and embodiments of the present disclosure will be described with reference to the accompanying drawings.

In this specification, a quantum computing device that predicts a trajectory of a quantum and manages decoherence of a quantum includes all various devices capable of providing results to a user by performing arithmetic processing. For example, according to an embodiment of the present disclosure, the quantum computing device for predicting a trajectory of a quantum and managing decoherence of a quantum may include both a computer and a server, or may be in the form of either one or the other.

Here, for example, the computer may include a notebook computer, a desktop computer, a laptop computer, and the like, which are equipped with a web browser.

The server may process information by communicating with an external device, and may include a database server.

According to an embodiment of the present disclosure, a quantum computing device that predicts a trajectory of a quantum and manages decoherence of the quantum may divide an input qubit signal of quantum computing into a prime number signal and a composite number signal, may rotate the divided prime number signal based on a vertex, which is formed in a 3D cone unit within the rotational spiral ascension dimension model of the complex number, may perform a predetermined offset operation on the rotated prime number signal whenever a carry occurs in the rotated prime number signal, may analyze a critical point where the decoherence of the quantum occurs, based on the rotated prime number signal, and may output a stabilized prime number signal, in which the predetermined decoherence of the quantum does not occur, when the rotated prime number signal reaches the critical point, and may generate a final output signal by recombining the stabilized prime number signal, and the composite number signal.

The quantum computing device for predicting a trajectory of a quantum and managing decoherence of a quantum may prevent the collapse of a quantum state and enhance stability by predicting and managing a critical point where quantum decoherence occurs, due to maintaining the periodicity and stability of a signal through complex rotation and carry-and-offset rules.

Hereinafter, the quantum computing device for predicting a trajectory of a quantum and managing decoherence of a quantum will be described in detail.

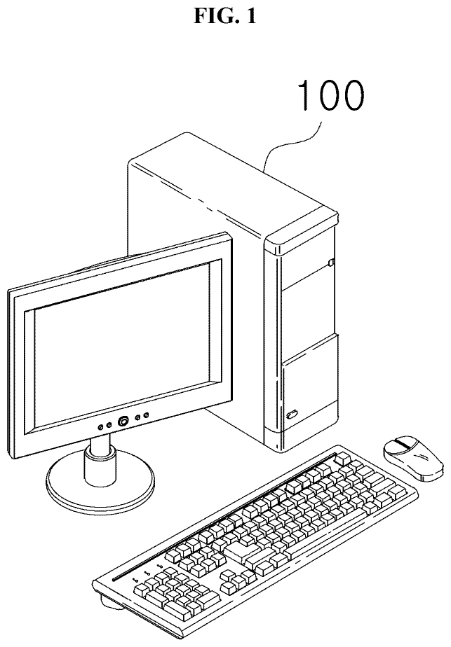

FIG. 1 is a diagram illustrating a quantum computing device that predicts a trajectory of a quantum and manages decoherence of a quantum, according to an embodiment of the present disclosure.

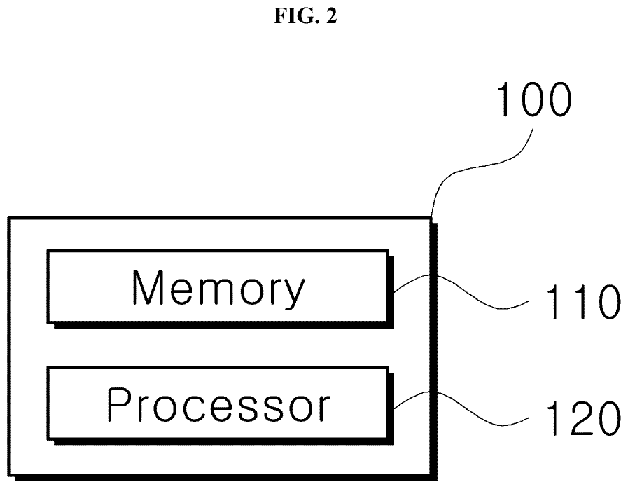

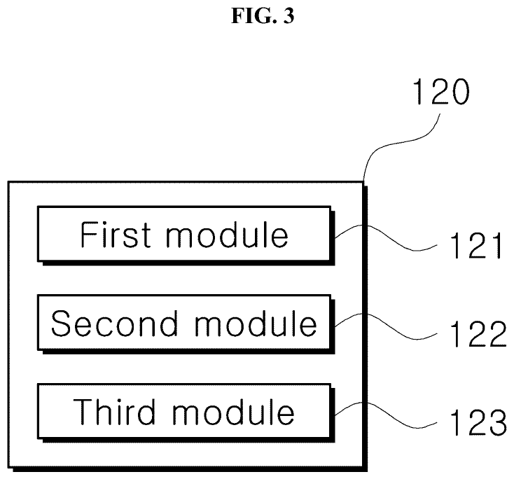

FIG. 2 is a diagram showing a configuration of the quantum computing device of FIG. 1. FIG. 3 is a diagram showing a configuration of a processor of FIG. 2.

Referring to FIGS. 1 to 3, a quantum computing device 100 may predict a trajectory of a quantum and may manage decoherence of a quantum by using a dynamic equilibrium operation, a base number wave, and a rotational spiral ascension dimension model of complex numbers.

The quantum computing device 100 may include a memory 110 and a processor 120.

The memory 110 may store data regarding an algorithm for controlling an operation of components within the present device, or a program for executing the algorithm. In addition, the at least one processor 120 may perform the above-described operations by using the data stored in the memory 110. Here, each of the memory 110 and the processor 120 may be implemented as separate chips. Moreover, the memory 110 and the processor 120 may be implemented as a single chip.

The memory 110 may store data that supports various functions of the present device, and a program for operations of the processor 120, may store input/output data, and may store a plurality of application programs (or applications) running on the present device, pieces of data for operations of the present device, and instructions. At least part of the application programs may be downloaded from an external server through wireless communication.

The memory 110 may include the type of a storage medium of at least one of a flash memory type, hard disk type, a solid state disk (SSD) type, a silicon disk drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Furthermore, the memory 110 may be separate from the present apparatus, but may be a database connected by wire or wirelessly.

The memory 110 may store at least one process related to decoherence management and trajectory prediction of a quantum. The processor 120 may perform an operation according to the process, and may control operations of predicting trajectory of a quantum and managing decoherence of a quantum.

Through a first module 121, the processor 120 may divide an input qubit signal of quantum computing into a prime number signal and a composite number signal.

In this case, when dividing the qubit signal into the prime number signal and the composite number signal, the processor 120 may use, through the first module 121, a zeta function of the base number wave that applies a weight to each of the prime number signal and the composite number signal. The base number wave refers to a new number system that represents and manipulates numbers by using boundary operation system of base numbers and complex rotation. The new number system may include an assignment angle radian, which is generated by performing complex rotation of 1/N, as wave and motion information by extending the existing number system. Structural transition and dimensional growth may be performed by arranging numbers with this information. The BNW system represents numbers by performing rotations based on the radix of a specific numeration system and visualizes these rotations as a 3D spiral. Each rotation depends on the radix of the numeration system. When the number is greater than or equal to a multiple of the radix, a carry occurs and thus moves to a new rotation or spiral layer.

In this case, the rotation denotes radian-based rotation. Each number k (0≤k<n) has its own angle

$${θ}_{k} = \frac{2 π k}{n}$$

and is expressed as e^{iθ}^{ₖ}=cos(θₖ)+i sin(θₖ) in a complex plane. Accordingly, variables grow in dimension, and are represented as one-dimensional (1D) waves, two-dimensional (2D) complex rotations, and 3D spiral paths. In this case, only the prime numbers form vertices in a 3D structure and undergo a dimension transition. The reason is that the prime number has a single-turn wave of the complex number for a dimension transition, but the composite number shares a single-turn wave with its divisor, thereby forming an unstable structure. Through these concepts, the structure of the Riemann zeta function is identified, and a BNW zeta function being a new prime number/composite number classification model is created.

That is, before processing a prime number signal through complex rotation, the processor 120 may divide, through the first module 121, the prime number signal into a composite number and a prime number, may perform initial classification based on a prime number search algorithm, may apply the BNW zeta function to the classified signal, and may adjust weights of the prime number signal and the composite number signal. The processor 120 may assign, through the first module 121, a high weight to the prime number signal, thereby reducing the occurrence of decoherence.

Here, the BNW zeta function may be a function obtained by modifying Riemann zeta function using the property of the Riemann hypothesis that only prime numbers gather at a critical line of 0 point, and may be a function obtained by applying a weight w(n) by distinguishing between a prime number ‘p’ and a composite number ‘n’. In other words, the BNW zeta function may appropriately adjust the contribution of prime numbers by assigning higher weights to prime numbers and assigning relatively lower weights to composite numbers.

At this time, the BNW zeta function may be expressed based on Equation 1 below, and the weight function may be expressed based on Equation 2 below.

$${ζ}_{BNW} ( s ) = {\sum }_{n = 1}^{∞} \frac{{e}^{i 2 {πθ}_{n}}}{{n}^{s}} \cdot w ( n ) \qquad [ Equation 1 ]$$

$$w ( n ) = \{ \begin{matrix}k & if n is prime \\ \frac{1}{log ( n )} & if n is composite\end{matrix} \qquad [ Equation 2 ]$$

Here, ‘k’ is a constant for emphasizing the contribution of a prime number, and the value of ‘k’ is used to appropriately adjust the contribution of the prime number. That is, the contributions of a prime number and a composite number may be set differently based on Equation 1 and Equation 2. For example, the 0-point critical point of the prime number may be clarified by emphasizing the contribution of the prime number and reducing the contribution of the composite number.

The processor 120 may rotate, through a second module 122, the divided prime number signal based on a vertex, which is formed in a 3D cone unit within a rotational spiral ascension dimension model of a complex number.

That is, the processor 120 may increase, through the second module 122, the stability of a quantum signal by processing the divided prime number signal through the rotation of the complex number. Here, the complex rotation is an important mechanism for creating a high-dimensional structure through the combination of waves and rotations. At this time, the spiral ascension dimension model is a dimension model created by the complex rotation. This spiral ascension dimension model switches to a new dimension whenever a carry point of a variable reaches the vertex of the cone unit, and forms an infinitely repeating spiral structure. Here, the dimension transition takes place at the vertex of the cone unit, which becomes the starting point in a new dimension.

In this case, the processor 120 may rotate, through the second module 122, each of the divided prime number signals depending on the complex cone unit, which is the 3D basic form of the prime number wave according to the base number wave theory. Here, when a critical point of a quantum is generated, the base number wave theory and the dynamic equilibrium operation theory, in which only the prime number signals are possible, may be reflected to the complex cone unit. The processor 120 may induce, through the second module 122, the rotation of a 3D complex cone unit structure through the rotation of the prime number signal and may adjust a weight with a BNW zeta function, thereby improving the stability of complex rotation.

Here, the complex rotation is a mathematical algorithm for maintaining the stability of the prime number signal and managing the periodicity. In this case, the processor 120 may express, through the second module 122, the periodic change of the prime number signal through rotation in a complex plane. As the number increases, the change is modeled as a spiral structure. The complex rotation algorithm is used to model the change in a quantum state and to enhance the stability of a prime number signal.

At this time, the processor 120 classifies, through the second module 122, a signal into a prime number and a composite number and performs specialized processing on each signal. The processor 120 adjusts, through the second module 122, a weight by using the BNW zeta function, which is created by using a Riemann zeta function, by applying the dynamic equilibrium operation, the base number wave, and the spiral ascension dimension model, thereby improving the stability of the complex rotation, and improving the accuracy of prime number classification. At this time, when a prime number and a composite number are classified, the processor 120 processes, through the second module 122, only the prime number as a complex rotation signal. In other words, the prime number is processed through complex rotation, and the composite number goes through an offset process. The prime number identification and classification algorithm is used in signal processing, data compression, error detection and correction, or the like.

The processor 120 may perform, through the second module 122, a predetermined offset operation on the rotated prime number signal whenever a carry occurs in the rotated prime number signal.

At this time, when a carry occurs in the rotated prime number signal, the processor 120 may initialize, through the second module 122, the rotated prime number signal while performing an offset operation on the rotated prime number signal. In other words, whenever a carry of a variable occurs, the processor 120 may perform, through the second module 122, an offset operation and may predict and manage a critical point where decoherence occurs, because the rotation is performed based on the vertex of the complex cone unit. Here, when the prime number signal reaches a critical point, the processor 120 may perform, through the second module 122, an offset operation, initialize the prime number signal, or stabilize the prime number signal.

A carry-and-offset algorithm plays an important role in managing critical points that occur during signal processing and maintaining the stability of the system. Furthermore, the carry-and-offset algorithm maintains the balance of the system by performing an offset operation when a signal carry occurs. Also, the carry-and-offset algorithm is used to solve the decoherence problem in quantum computing and to increase the stability of a signal.

The processor 120 may analyze, through the second module 122, the critical point where quantum decoherence occurs, based on the rotated prime number signal.

At this time, when analyzing the critical point where decoherence of a quantum occurs, the processor 120 may use, through the second module 122, a 0-point interaction function, which is a transition function in the complex plane. Moreover, when analyzing the critical point where decoherence of a quantum occurs, the processor 120 may use, through the second module 122, the 0-point interaction function, to which a function indicating a smooth transition in the complex plane is applied. For example, the function indicating the smooth transition may be the sigmoid function.

Here, the 0-point interaction function is a concept for describing the dynamic equilibrium state and the complex rotation centered on point 0 at a dimensional connection point. That is, the 0-point interaction function is a concept in which rotation occurs in the dynamic equilibrium state of −1, 0, or 1, and regression and structural transition occur at point 0. In other words, at point 0, information from the previous dimension is entered, and there is potential energy (0-dimensional phase information energy) that affects the next structure. Rotation at point 0 includes information from the previous dimension and affects the structure of the next dimension. The 0-point interaction function is numerically observed as 0, but it includes important information and energy, and thus it is an important concept that reflects the critical point at point 0. At this time, because the operation structure is generated by complex rotation, the wave motion of the operation structure is included at point 0.

At this time, according to the dynamic equilibrium operation theory, the 0-point interaction function h(z) may be expressed based on Equation 3 below.

$$h ( z ) = f ( z ) ( 1 - σ ( z ) ) + g ( z ) σ ( z ) \qquad [ Equation 3 ]$$

Here, f(z) may be a first function in the form of a complex number; g(z) may be a second function in the form of a complex number; and σ(z) may be a sigmoid function.

In this case, the sigmoid function is used to represent a smooth transition in the complex plane. Here, the sigmoid function may be used as a nonlinear function, mainly as an activation function in neural networks, in the context of DEO theory and 0-point interaction function.

Furthermore, the sigmoid function may represent the transition of a system state while maintaining the continuity of the function. The sigmoid function is advantageous in describing continuous rotations and transitions in the complex plane.

Moreover, the sigmoid function is useful for modeling a process in which the system gradually moves to a new state. The sigmoid function plays an important role in describing complex physical phenomena such as quantum decoherence.

Here, the sigmoid function may output a value between 0 and 1, regardless of an input value. Furthermore, the sigmoid function may output a value, which is close to 0 when the input value is small, and which is close to 1 when the input value is great. This characteristic of the sigmoid function is useful for representing smooth changes, not abrupt changes, during a transition process.

The sigmoid function σ(z) may be expressed based on Equation 4 below.

$$σ ( z ) = \frac{1}{1 + {e}^{- k Re ( z )}} \qquad [ Equation 4 ]$$

Here, Re(z) may be the real part of the complex number z. k may be a tunable parameter. At this time, the parameter may be a parameter for controlling the steepness of the function.

The sigmoid function σ(z) has an S-shaped graph. As the value of z increases, the output value may get closer to 1. As the value of z decreases, the output value may get closer to 0. At this time, the sigmoid function σ(z) is differentiable, which allows the use of a backpropagation algorithm.

That is, the sigmoid function σ(z) in Equation 3 may provide a smooth transition from f(z) to g(z) while the state of the system does not change abruptly. Here, the sigmoid function σ(z) may adjust the output of the 0-point interaction function h(z) depending on the input value z, by determining weights of the two functions f(z) and g(z). At this time, when the real part of z is great, the influence of g(z) may be significant. When the real part of z is small, the influence of f(z) may be significant.

The 0-point interaction function is a mathematical tool for dimension transition and critical point analysis, and is used to analyze and process a critical point of a signal. Moreover, when the signal reaches point 0, the 0-point interaction function transitions to a new dimension through interaction. Furthermore, the 0-point interaction function is used to manage decoherence, to analyze a critical point, and to maintain stability of a signal.

When the rotated prime number signal reaches the critical point, the processor 120 may output, through a third module 123, a stabilized prime number signal, in which the predetermined decoherence of a quantum does not occur. At this time, when the rotated prime number signal reaches a critical point, the processor 120 may initialize, through the third module 123, the rotated prime number signal while performing a predetermined offset operation on the rotated prime number signal.

Here, the processor 120 sets, through the third module 123, an initial condition of a quantum state and models a process in which the system interacts with an external environment and transitions to a higher dimension. In other words, the processor 120 expresses, through the third module 123, the initial quantum state as a basis vector and a complex number coefficient and performs a dimension transition through external interactions. The quantum state initialization condition and transformation algorithm plays an important role in fields such as quantum computing, quantum communication, and quantum cryptography.

The processor 120 may generate, through the third module 123, a final output signal by recombining a composite number signal and the prime number signal stabilized without decoherence.

At this time, when the recombined final output signal does not satisfy the quality criteria of the preset reference output signal, the processor 120 may generate, through the third module 123, the final output signal by repeatedly recombining the stabilized prime number signal and the composite number signal until the recombined final output signal satisfies the quality criteria of the reference output signal. Here, the processor 120 may generate, through the third module 123, the final signal in consideration of the stability and periodicity of the prime number signal and the composite number signal. In this case, the processor 120 may guarantee, through the third module 123, the quality of the final output signal by combining signals after the offset operation and complex rotation.

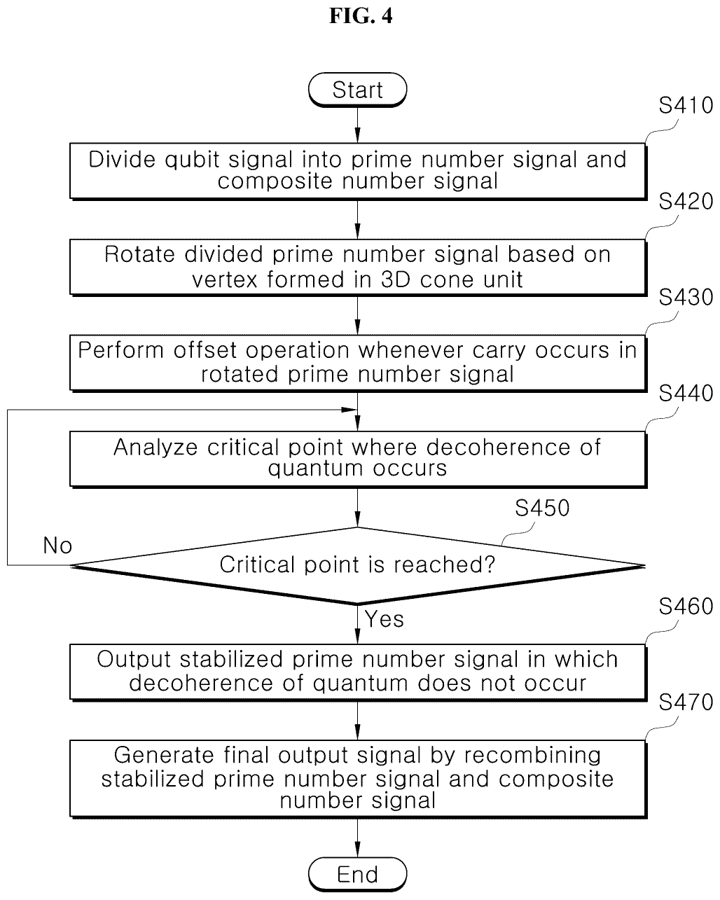

FIGS. 4 to 13 are diagrams illustrating a process of predicting a trajectory of a quantum and managing decoherence of a quantum, according to an embodiment of the present disclosure.

Referring to FIG. 4, a method of predicting a trajectory of a quantum and managing decoherence of a quantum may include first step S410, second step S420, third step S430, fourth step S440, fifth step S450 and S460, and sixth step S470. The method of predicting a trajectory of a quantum and managing decoherence of a quantum searches for and manages the quantum decoherence point of a prime number by utilizing the state where the vertices of the complex cone unit have only prime numbers, through dynamic equilibrium operation DEO, base number wave BNW, and spiral ascension dimension model SADM, thereby enhancing the stability of quantum computing.

The processor 120 may divide, through the first module 121, an input qubit signal of quantum computing into a prime number signal and a composite number signal (S410). Afterwards, the processor 120 may rotate, through the second module 122, the divided prime number signal based on a vertex, which is formed in a 3D cone unit within a rotational spiral ascension dimension model of a complex number (S420).

Afterwards, the processor 120 may perform, through the second module 122, a predetermined offset operation on the rotated prime number signal whenever a carry occurs in the rotated prime number signal (S430). Afterwards, the processor 120 may analyze, through the second module 122, a critical point where decoherence of a quantum occurs, based on the rotated prime number signal (S440).

Afterwards, when the rotated prime number signal reaches the critical point (S450), the processor 120 may output, through the third module 123, a stabilized prime number signal, in which the predetermined decoherence of a quantum does not occur (S460). Afterwards, the processor 120 may generate, through the third module 123, a final output signal by recombining a composite number signal and the prime number signal stabilized without decoherence (S470).

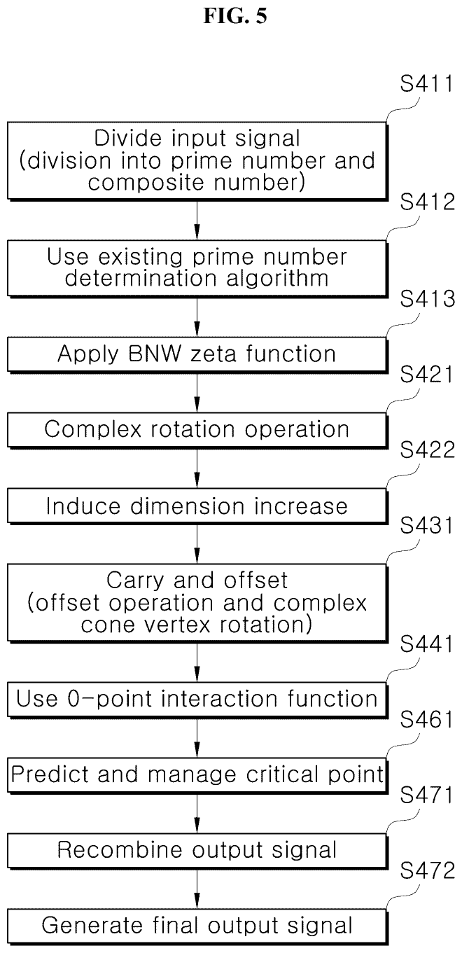

In other words, as illustrated in FIG. 5, the processor 120 starts, through the first module 121, a step of dividing a qubit signal received from a main NODE into a prime number and a composite number (S411).

Afterwards, the processor 120 classifies, through the first module 121, the composite number and the prime number signal by using an is prime function by using the existing prime number determination algorithm (S412). At this time, the is prime function is a function of determining whether a given integer ‘n’ is a prime number, and uses the property of a prime number, which is a natural number greater than 1 that is not divisible by anything other than 1 and itself.

Afterwards, the processor 120 assigns, through the first module 121, a weight to the prime number by supplementing the existing prime number determination algorithm and applies a BNW zeta function for classifying a signal in a method of relatively reducing the contribution of the composite number (S413). At this time, the contribution of the prime number signal is emphasized through the weight.

Afterwards, the processor 120 processes, through the second module 122, a signal corresponding to the prime number through a complex rotation (S421). Through the second module 122, the processor 120 contributes to increasing the stability and periodicity of the prime number signal in a complex rotation operation.

Afterwards, the processor 120 searches, through the second module 122, for a dimension increase structure for inducing dimension increase when a carry occurs (S422). Afterwards, the processor 120 performs carry-and-offset through the second module 122 (S431).

Afterwards, the processor 120 uses, through the second module 122, a 0-point interaction function (S441) and predicts and manages a critical point (S461). At this time, the BNW zeta function analyzes and manages a process in which the prime number signal operating in conjunction with a complex cone unit reaches the critical point.

Afterwards, the processor 120 may recombine, through the third module 123, an output signal (S471) and generate a final output signal (S472).

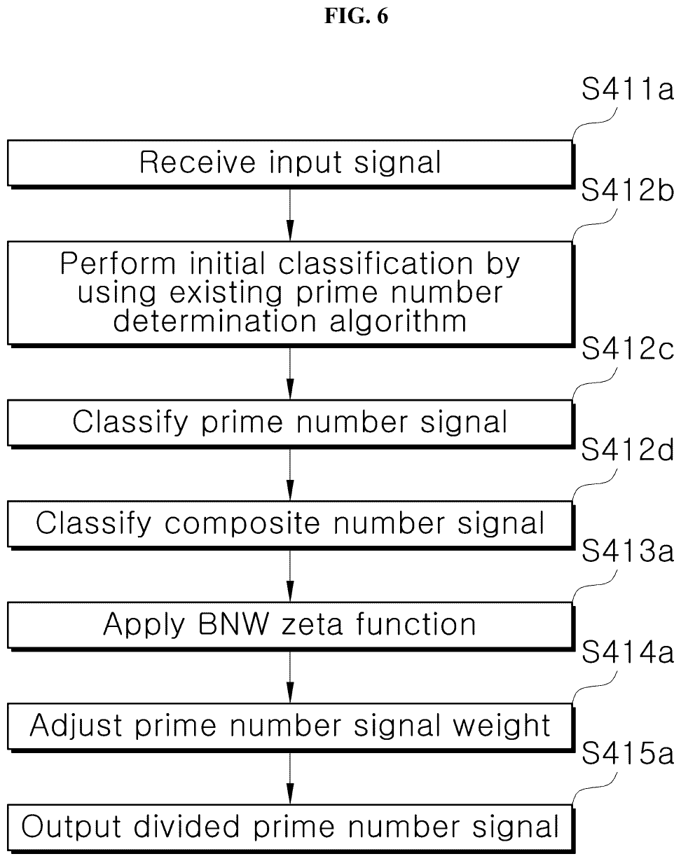

In detail, as illustrated in FIG. 6, in the first step (S410), the processor 120 receives, through the first module 121, the input qubit signal of the quantum computing (S411a) and performs initial classification by using the existing prime number determination algorithm (S412b). At this time, the processor 120 classifies, through the first module 121, the prime number signal (S412c) and classifies the composite number signal (S412d).

After this, the processor 120 supplements, through the first module 121, the prime number determination algorithm obtained by applying the BNW zeta function (S413a), adjusts the prime number signal weight (S414a), and outputs the divided prime number signal (S415a).

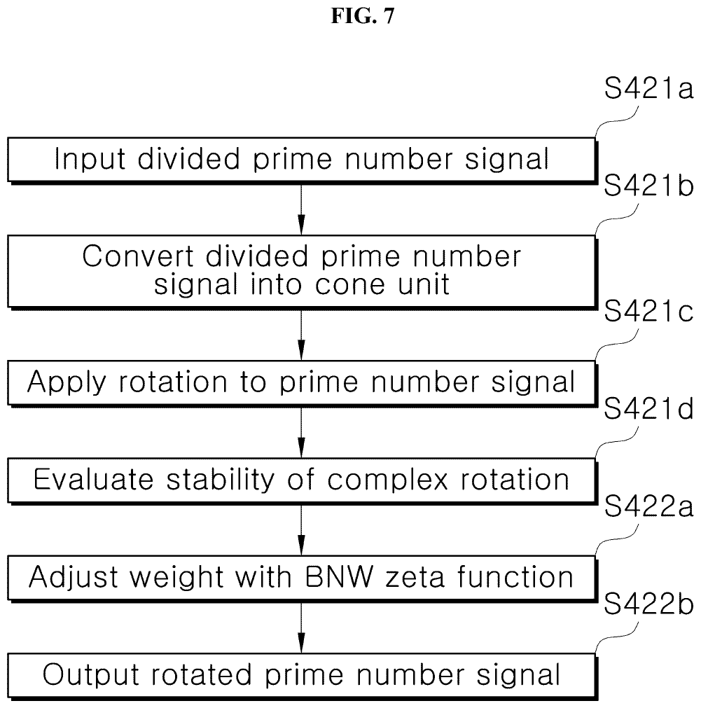

As illustrated in FIG. 7, in second step S420, when the divided prime number signal is input (S421a), the processor 120 converts, through the second module 122, the divided prime number signal into a 3D spiral complex cone unit (S421b) and applies a rotation to the prime number signal (S421c).

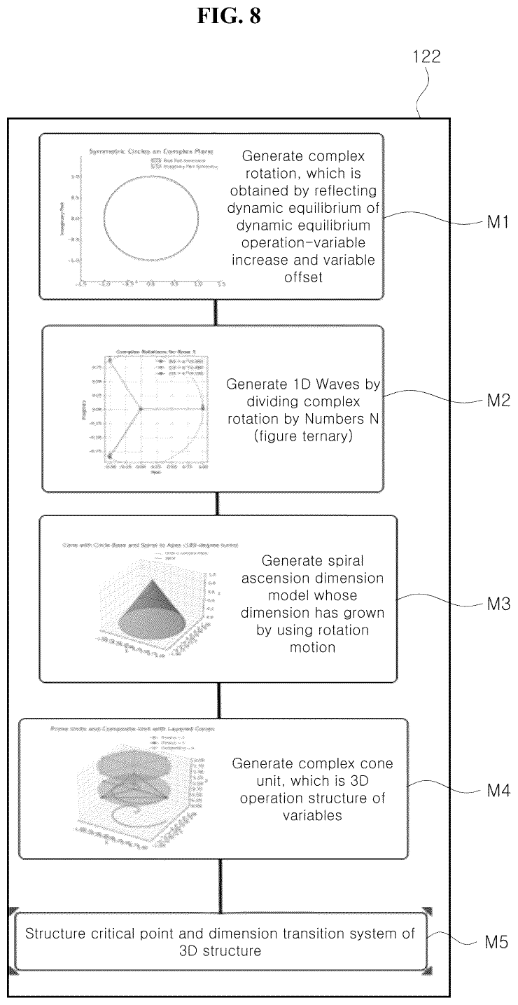

At this time, as shown in FIG. 8, the processor 120 may generate, through the second module 122, a base number wave and a spiral ascension dimension model for predicting the dynamic system of a quantum and a variable. Here, the base number wave is used to create a 1D wave by dividing a complex rotation, which is a mathematical tool having the concept of physical motion, by a variable ‘N’.

For example, when the complex rotation is divided by a periodic number N by using the 1-turn Euler formula, in the case of the number ‘N’, an assignment angle radian has 360 degrees/N. The rotation may be made by using this as the 1D wave to generate structures of a 2D circle and 3D cone unit.

Through the dimensional structures, the structure of a 3D spiral cone unit of complex rotation is created. Unlike a conventional computational system, the dynamic system of variables and quanta may be identified through the spiral ascension dimension model, which draws the geometric structure depending on the results of calculations in the numerical system.

In other words, the processor 120 may generate, through the second module 122, a complex rotation model (M1), which is obtained by reflecting the dynamic equilibrium of variable increase and variable offset, may generate a 1D wave model (M2) by dividing the complex rotation into numbers ‘N’, may generate a spiral ascension dimension model (M3) whose dimension has grown by using rotation motion, may generate a complex cone unit model (M4), which is a 3D operation structure of variables, and may finally generate a structured model (M5) of a critical point and dimension transition system of the 3D structure.

In this case, the spiral ascension dimension model (M3) refers to a theory that a variable offset process occurs to be balanced with 0 when a variable increases from 0 being a state of no variable, and the symmetric dynamic equilibrium of a variable increase and a variable offset creates a motion called complex rotation, and predicts the dynamic system of quanta and variables through this theory.

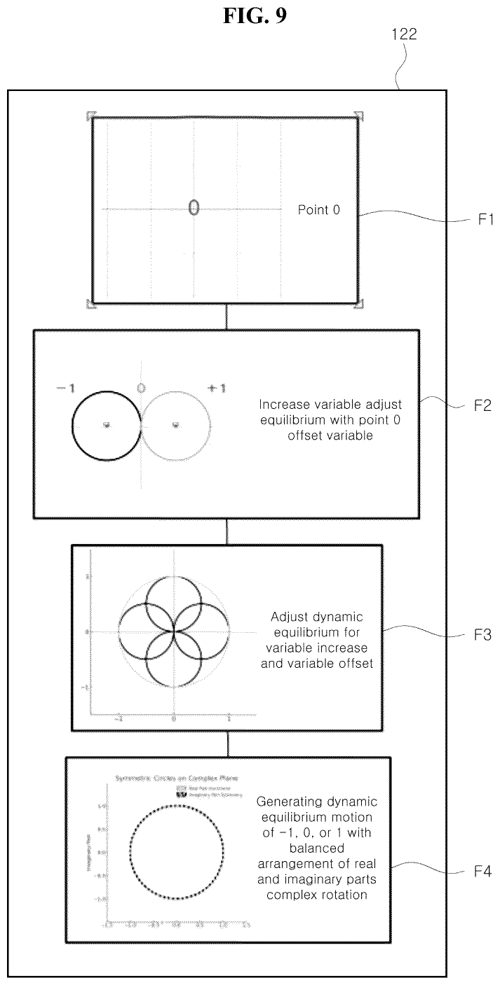

Here, as illustrated in FIG. 9, the 0-point interaction function is a concept for describing the dynamic equilibrium state and the complex rotation centered on point 0 (F1) at a dimensional connection point. In other words, the 0-point interaction function forms a dynamic equilibrium state of −1, 0, or 1 (F2). However, when a variable increases from 0, which is a state of no variable, the 0-point interaction function may adjust the dynamic equilibrium for a variable increase and a variable state to be balanced with 0 (F3), and may generate a motion of complex rotation by generating a dynamic equilibrium motion of −1, 0, or 1 with the balanced arrangement of real and imaginary parts (F4).

Afterwards, in second step S420, the processor 120 may evaluate, through the second module 122, the stability of the complex rotation of a prime number signal (S421d), may adjust a weight with a BNW zeta function (S422a), and may output the rotated prime number signal (S422b).

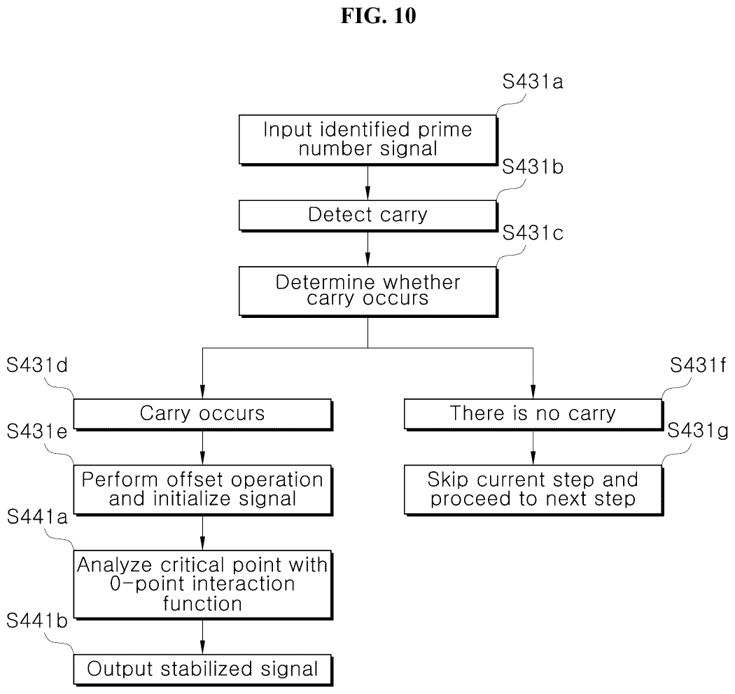

As shown in FIG. 10, in third step S430 and fourth step S440, when the rotated prime number signal is input (S431a), the processor 120 detects, through the second module 122, a carry occurring due to interaction (S431b), determines whether a carry occurs (S431c), manages decoherence by performing an offset operation and initializing a signal (S431e) when the carry occurs (S431d), analyzes and manages a critical point with a 0-point interaction function (S441a), and outputs a stabilized signal (S441b). Moreover, when there is no carry (S431f), the processor 120 skips, through the second module 122, the current step and proceeds to the next step because the condition is not satisfied (S431g). In other words, when there is no carry (S431f), the processor 120 may determine, through the second module 122, that the condition is not satisfied, may skip the current step, and may perform the next step.

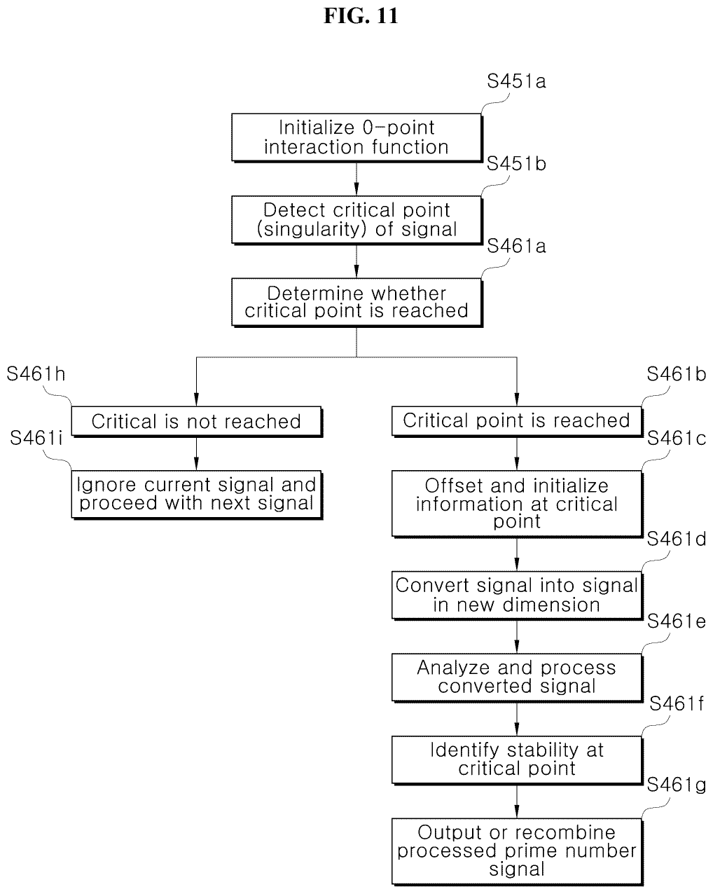

As shown in FIG. 11, in fifth step S450, the processor 120 initializes, through the third module 123, a 0-point interaction function (S451a) and detects a critical point of a signal (S451b). At this time, in sixth step S460, the processor 120 determines, through the third module 123, whether the critical point is reached (S461a). When the critical point is reached (S461b), the processor 120 offsets and initializes information at the critical point (S461c), and converts the signal into a signal in a new dimension (S461d). Also, in sixth step S460, the processor 120 analyzes and processes, through the third module 123, the converted signal (S461e), identifies stability at the critical point (S461f), and outputs or recombines the processed prime number signal (S461g). Also, in sixth step S460, when the critical point is not reached (S461h), the processor 120 ignores, through the third module 123, a current signal because the condition is not satisfied, and proceeds with the next signal (S461i). That is, when the critical point is not reached (S461h), the processor 120 may determine, through the third module 123, that the condition is not satisfied, may ignore the current signal, and may proceeds with the next iteration (“continue” in programming).

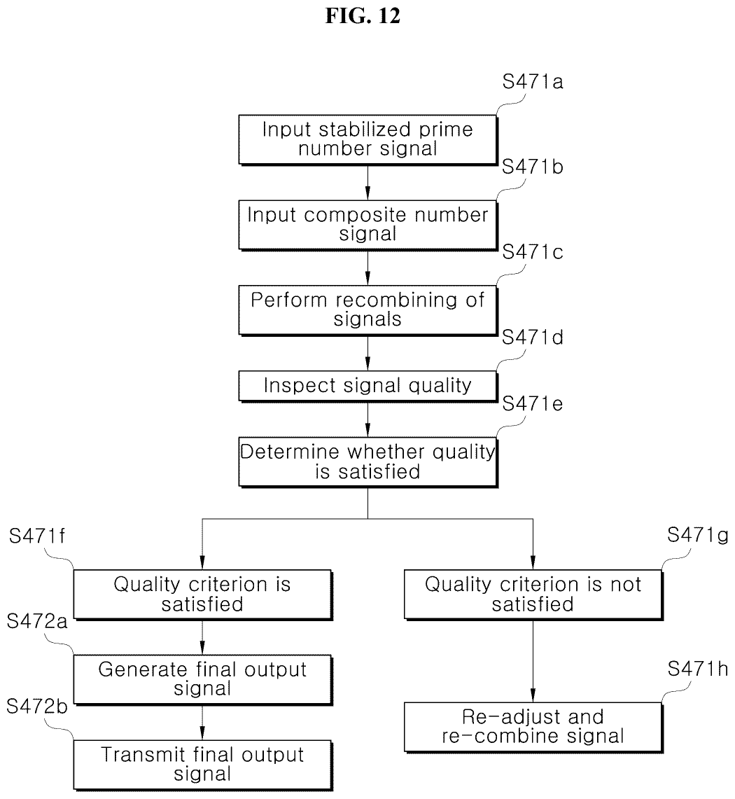

As shown in FIG. 12, in seventh step S470, when a stabilized prime number signal is input (S471a), a composite number signal is input (S471b). The processor 120 performs, through the third module 123, recombining of the stabilized prime number signal and a composite number signal (S471c), inspects signal quality (S471d), and determines whether the quality is satisfied (S471e). At this time, in seventh step S470, when a quality criterion is satisfied (S471f), the processor 120 generates, through the third module 123, a final output signal (S472a) and transmits the final output signal (S472b). Also, in seventh step S470, when the quality criterion is not satisfied (S471g), the processor 120 re-adjusts and re-combines the signal through the third module 123 (S471g).

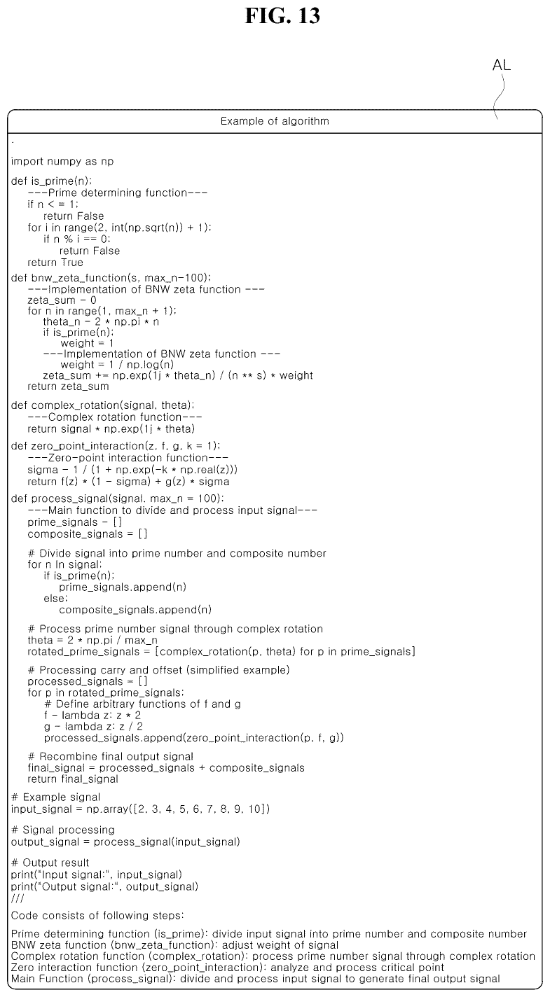

An example of coding for a process of predicting a trajectory of a quantum and managing decoherence of a quantum is shown in FIG. 13.

FIG. 13 illustrates an algorithm AL for processing a quantum signal by applying complex rotation, prime number determination, and a carry-and-offset rule to alleviate decoherence of qubits and to perform stable signal processing in a quantum computing environment.

A quantum complex rotation signal processing algorithm of the present disclosure presents an innovative approach to quantum computing and signal processing by integrating various technical elements such as DEO, BNW, complex rotation, prime number identification and classification, carry-and-offset, a 0-point interaction function, and quantum state initialization and transformation. In this way, it may make an important contribution to maintaining the stability of quantum signals and solving decoherence problems.

That is, the quantum complex rotation signal processing algorithm of the present disclosure maximizes the stability and efficiency of quantum signals in a quantum computing environment by increasing the stability of quantum signals and predicting and managing critical points. This process plays an important role in improving the performance and reliability of quantum computers.

At least one component may be added or deleted to correspond to the performance of the components illustrated in FIGS. 1 to 3, 8, 9, and 13. Furthermore, it will be easily understood by those skilled in the art that mutual locations of the components may be changed to correspond to the performance or structure of the system.

FIGS. 4 to 7 and 10 to 12 illustrate that operations are performed sequentially. However, this is merely illustrative of the technical idea of the present disclosure. Those skilled in the art to which an embodiment of the present disclosure belongs may apply various modifications and variations by changing and performing the order illustrated in FIGS. 4 to 7 and 10 to 12 or performing one or more operations among a plurality of operations in parallel without departing from the essential characteristics of an embodiment of the present disclosure. The embodiment in FIGS. 4 to 7 and 10 to 12 is not limited to a time-series order.

The disclosed technology is as follows. However, it does not mean that a specific embodiment should include all of the following effects or only the following effects, and thus the scope of the disclosed technology should not be construed as being limited thereby.

According to the present disclosure, the stability may be improved by splitting an input signal into prime and composite numbers, and applying complex rotation to a prime signal. This may make a change in quantum state predictable and may help reduce decoherence.

According to the present disclosure, signal processing through complex rotation and carry-and-offset may contribute to reducing noise and improving signal clarity. Moreover, a critical point may be predicted and managed through a carry-and-offset stage. In particular, a part that analyzes and processes the critical point by using a 0-point interaction function may be effective in managing a point in time when decoherence occurs.

According to the present disclosure, the computation speed may be increased by splitting a signal into prime numbers and composite numbers and performing optimized processing for each of the prime numbers and each of the composite numbers. Also, an operation of utilizing complex rotation may be performed faster and more efficiently. This is expected to improve performance, especially in an operation associated with the conversion of quantum bits.

According to the present disclosure, signal processing using complex rotation and base number wave may provide high precision compared with conventional computational methods. Furthermore, the accuracy of an operation may be improved by accurately predicting and managing the critical point through the 0-point interaction function.

According to the present disclosure, the modular structure of an algorithm may be easily integrated into various quantum computing systems, thereby increasing the scalability of a system. Besides, in addition to quantum signal processing, it may be applied to various fields such as data transfer stabilization and quantum encryption.

According to the present disclosure, a main method of managing decoherence in current quantum computing is error correction, but conventional methods mainly focus on improving stability at a hardware level. On the other hand, an algorithm of the present disclosure focuses on signal processing and critical point management.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

What is claimed is:

1. A quantum computing device that predicts a trajectory of a quantum and manages decoherence of the quantum by using a dynamic equilibrium operation, a base number wave, and a rotational spiral ascension dimension model of a complex number, the quantum computing device comprising:
a memory configured to store at least one process related to managing the decoherence of the quantum and predicting the trajectory of the quantum; and
a processor configured to perform an operation according to the process,
wherein the processor includes:
a first module configured to divide an input qubit signal of quantum computing into a prime number signal and a composite number signal;
a second module configured to rotate the divided prime number signal based on a vertex, which is formed in a 3D cone unit within the rotational spiral ascension dimension model of the complex number, to perform a predetermined offset operation on the rotated prime number signal whenever a carry occurs in the rotated prime number signal, and to analyze a critical point where the decoherence of the quantum occurs, based on the rotated prime number signal; and
a third module configured to output a stabilized prime number signal, in which the predetermined decoherence of the quantum does not occur, when the rotated prime number signal reaches the critical point, and to generate a final output signal by recombining the stabilized prime number signal, and the composite number signal.

2. The quantum computing device of claim 1, wherein the first module is configured to:
when dividing the qubit signal into the prime number signal and the composite number signal, use a zeta function of the base number wave that applies a weight to each of the prime number signal and the composite number signal.

3. The quantum computing device of claim 1, wherein the second module is configured to:
when the carry occurs in the rotated prime number signal, initialize the rotated prime number signal while performing the offset operation on the rotated prime number signal.

4. The quantum computing device of claim 1, wherein the second module is configured to:
when analyzing the critical point where the decoherence of the quantum occurs, use a 0-point interaction function.

5. The quantum computing device of claim 4, wherein the second module is configured to:
when analyzing the critical point where the decoherence of the quantum occurs, use the 0-point interaction function, to which a function indicating a smooth transition in a complex plane is applied.

6. The quantum computing device of claim 5, wherein the function indicating the smooth transition is a sigmoid function.

7. The quantum computing device of claim 1, wherein the third module is configured to:
when the rotated prime number signal reaches the critical point, initialize the rotated prime number signal while performing the predetermined offset operation on the rotated prime number signal.

8. The quantum computing device of claim 1, wherein the third module is configured to:
when the recombined final output signal does not satisfy a quality criterion of a predetermined reference output signal, generate the final output signal by repeatedly recombining the stabilized prime number signal and the composite number signal until the recombined final output signal satisfies the quality criterion of the reference output signal.

9. A method of predicting a trajectory of a quantum and managing decoherence of the quantum by using a dynamic equilibrium operation, a base number wave, and a rotational spiral ascension dimension model of a complex number, which is performed by a quantum computing device, the method comprising:
dividing, by a first module of the quantum computing device, an input qubit signal of quantum computing into a prime number signal and a composite number signal;
rotating, by a second module of the quantum computing device, the divided prime number signal based on a vertex, which is formed in a 3D cone unit within the rotational spiral ascension dimension model of the complex number;
performing, by the second module, a predetermined offset operation on the rotated prime number signal whenever a carry occurs in the rotated prime number signal;
analyzing, by the second module, a critical point where the decoherence of the quantum occurs, based on the rotated prime number signal;
outputting, by a third module of the quantum computing device, a stabilized prime number signal, in which the predetermined decoherence of the quantum does not occur, when the rotated prime number signal reaches the critical point; and
generating, by the third module, a final output signal by recombining the stabilized prime number signal, and the composite number signal.

10. A computer-readable recording medium storing a program for executing the method of claim 9 in combination with a computer.
